(19) United States
(12) Patent Application Publication
(10) Pub. No.: US 2007/0043888 A1
(43) Pub. Date: Feb. 22, 2007

(54) Information processing apparatus and access method

(75) Inventors: Yoshihisa Suzuki, Fussa-shi (JP); Toru Hanada, Ome-shi (JP); Hiroshi Yamazaki, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/500,192

(22) Filed: Aug. 7, 2006

(30) Foreign Application Priority Data
Aug. 19, 2005 (JP) 2005-238925

(51) Int. Cl. G06F 13/38

(52) U.S. Cl. 710/62

(57) ABSTRACT

According to one embodiment, an information processing apparatus includes a main body, connection ports to which external storage devices are detachably connectable, a nonvolatile memory which stores mode designation information items which correspond to the connection ports and designate whether each of the external storage devices connected to the associated connection ports is to be handled as a hard disk drive or a flexible disk drive, a drive number assignment unit which assigns, in a case where the external storage device is connected to at least one of the connection ports, one of a first drive number which designates the hard disk drive and a second drive number which designates the flexible disk drive to the external storage device, based on the mode designation information corresponding to the at least one of the connection ports.

### CROSS-REFERENCE TO RELATED APPLICATIONS

This application is based upon and claims the benefit of priority from Japanese Patent Application No. 2005-238925, filed Aug. 19, 2005, the entire contents of which are incorporated herein by reference.

### BACKGROUND

1. Field

One embodiment of the invention relates to an information processing apparatus such as a personal computer, and more particularly to an information processing apparatus having a plurality of connection ports to which external storage devices are detachably connectable, and an access method for use in the apparatus.

2. Description of the Related Art

In recent years, various types of portable personal computers, such as laptop or notebook computers, have been developed. This type of computer has a plurality of connection ports, such as a universal serial bus (USB) interface and an IEEE1394 interface, for extending the functions of the computer. Various external storage devices can be connected to such connection ports.

In usual cases, however, the external storage device, which is connected to any one of the connection ports, is handled as a removable medium. Thus, the external storage device cannot be handled as a bootable disk drive such as a hard disk drive (HDD) or a flexible disk drive (FDD). The use of the external storage device is relatively limited.

Jpn. Pat. Appln. KOKAI Publication No. 2004-151785 discloses a USB storage device which incorporates a flash memory. Upon receiving an inquiry from a host computer, the USB storage device returns to the host computer a response indicating that the USB storage device is a flexible disk drive. Thereby, the USB storage device is recognized by the host computer as a flexible disk drive in a pseudo-fashion.

However, if the external storage device is equipped with such a dedicated function for causing itself to be recognized as a flexible disk drive in a pseudo-fashion, the manufacturing cost of the external storage device would increase. On the other hand, if an ordinary external storage device which is not equipped with such a dedicated function cannot be handled as a flexible disk drive.

Under the circumstances, there is a need to realize a novel function for handling an external storage device as a user's intended disk drive (hard disk drive or a flexible disk drive) without equipping the external storage device with a special function.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus, as viewed from the front side, according to an embodiment of the present invention;

FIG. 2 is an exemplary perspective view showing the external appearance of the information processing apparatus shown in FIG. 1, as viewed from the rear side;

FIG. 3 is an exemplary perspective view showing an example of an external storage device which is connectable to the information processing apparatus shown in FIG. 1;

FIG. 4 is an exemplary block diagram showing the system configuration of the information processing apparatus shown in FIG. 1;

FIG. 5 is an exemplary block diagram illustrating the functional configuration of a system BIOS which is used in the information processing apparatus shown in FIG. 1;

FIG. 6 is an exemplary view showing a structure of a disk driver routine in the system BIOS which is used in the information processing apparatus shown in FIG. 1;

FIG. 7 is an exemplary view showing an example of mode assignment to USB ports which are provided on the information processing apparatus shown in FIG. 1;

FIG. 8 is an exemplary view for explaining an example of a drive number table which is used in the information processing apparatus shown in FIG. 1;

FIG. 9 is an exemplary view showing an example of modes of use of the USB ports, which are supported by the information processing apparatus shown in FIG. 1;

FIG. 10 is an exemplary flow chart for explaining the operation of the disk driver routine shown in FIG. 6;

FIG. 11 is an exemplary view showing an example of a system setup screen which is used in the information processing apparatus shown in FIG. 1;

FIG. 12 is an exemplary view showing an example of a mode setting screen which is displayed on the system setup screen shown in FIG. 11;

FIG. 13 is an exemplary flow chart for describing a drive number assignment process which is executed by the system BIOS that is used in the information processing apparatus shown in FIG. 1; and

FIG. 14 is an exemplary flow chart illustrating the procedure of a process which is executed when the information processing apparatus shown in FIG. 1 is powered on.

### DETAILED DESCRIPTION

Various embodiments according to the invention will be described hereinafter with reference to the accompanying drawings. In general, according to one embodiment of the invention, an information processing apparatus includes: a main body; a plurality of connection ports which are provided in the main body and to which external storage devices are detachably connectable; a nonvolatile memory which stores a plurality of mode designation information items which correspond to the plurality of connection ports and designate whether each of the external storage devices connected to the associated connection ports is to be handled as a hard disk drive or a flexible disk drive; a connection detection unit which executes a connection detection process for determining whether the external storage devices are connected to the connection ports on a connection port by connection port basis; and a drive number assignment unit which assigns, in a case where the external storage device is connected to at least one of the plurality of connection ports, one of a first drive number which designates the hard disk drive and a second drive number which designates the flexible disk drive to the external storage device connected to said at least one of the connection ports, based on the mode designation information corresponding to said at least one of the connection ports.

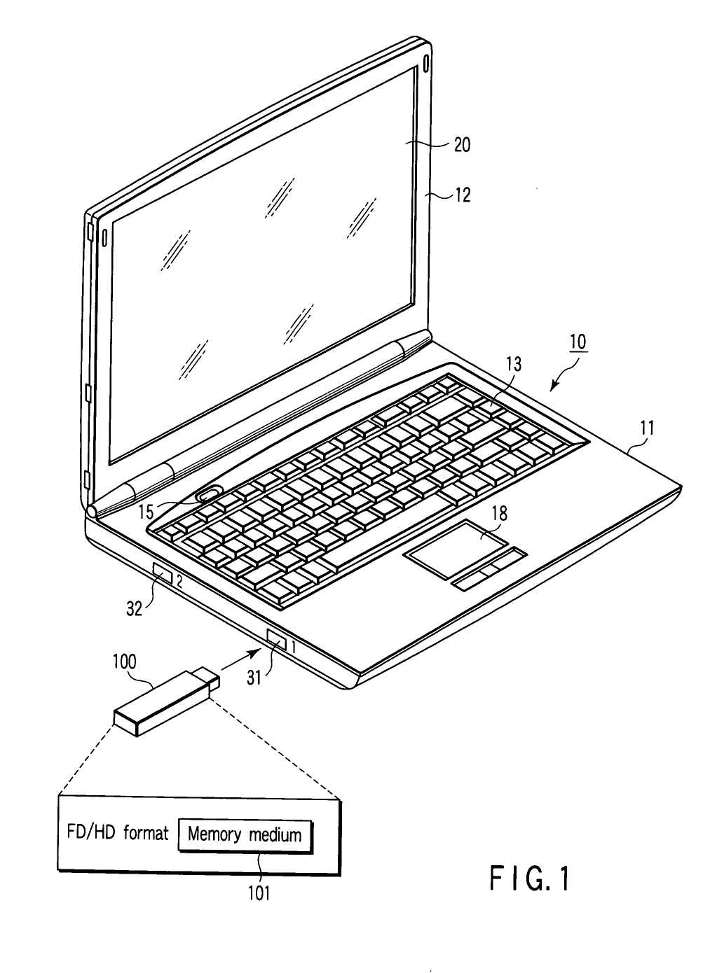

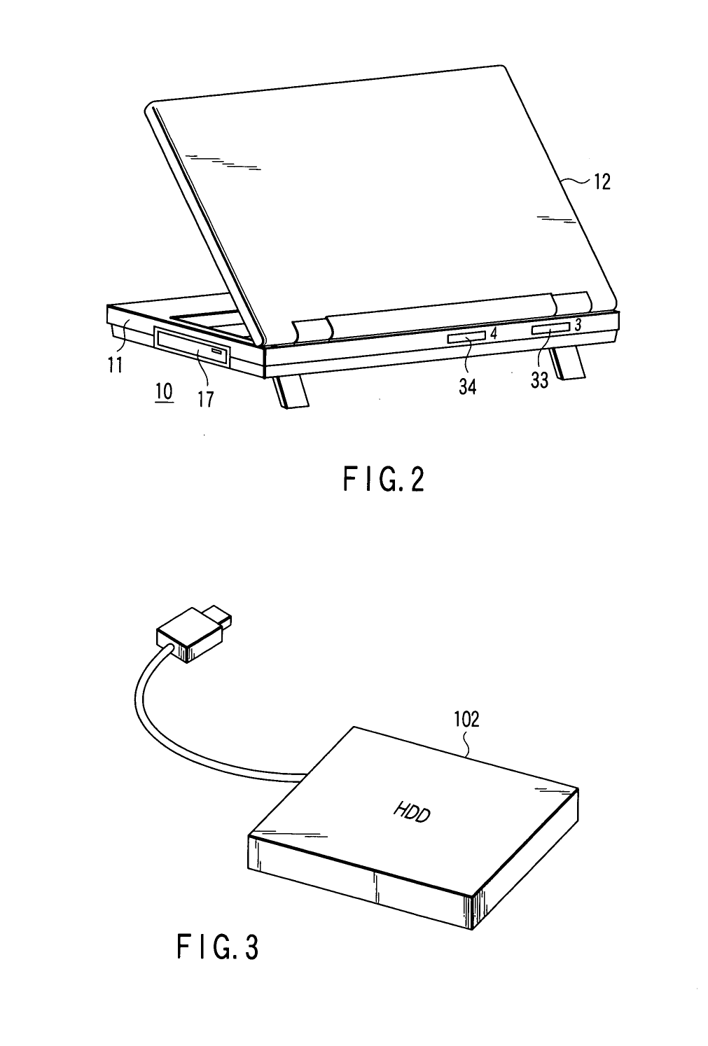

To begin with, the structure of an information processing apparatus according to an embodiment of the invention is described referring to FIG. 1 and FIG. 2. The information processing apparatus is realized, for example, as a battery-powerable portable notebook personal computer 10.

FIG. 1 is a perspective view showing the computer 10, as viewed from the front side, in the state in which a display unit is opened. FIG. 2 is a perspective view showing the computer 10, as viewed from the rear side.

The computer 10 comprises a computer main body 11 and a display unit 12. A display device that is composed of an LCD (Liquid Crystal Display) 20 is built in the display unit 12. The display screen of the LCD 20 is positioned at an approximately central part of the display unit 12.

The display unit 12 is supported on the computer main body 11 such that the display unit 12 is freely rotatable between an open position where the top surface of the computer main body 11 is exposed and a closed position where the top surface of the computer main body 11 is covered. The computer main body 11 has a thin box-shaped casing. A keyboard 13, a power button switch 15 for powering on/off the computer 10, and a touch pad 18 are disposed on the top surface of the computer main body 11. As shown in FIG. 2, an optical disc drive 17, such as a CD/DVD drive, is accommodated in the computer main body 11.

As shown in FIG. 1, two connection ports 31 and 32, to which an external storage device is detachably connectable, are provided on a left side surface of the computer main body 11. In addition, as shown in FIG. 2, two connection ports 33 and 34, to which an external storage device is detachably connectable, are provided on a rear side surface of the computer main body 11.

Each of the connection ports 31, 32, 33 and 34 is composed of a connector that supports, e.g. the Universal Serial Bus (USB) standard or the IEEE1394 standard. An external storage device 100, which supports the USB standard or IEEE1394 standard, can be connected, as needed, to each of the connection ports 31, 32, 33 and 34.

In the description below, it is assumed that each of the connection ports 31, 32, 33 and 34 is composed of a connector that supports the USB standard. Hereinafter, the connection ports 31, 32, 33 and 34 are referred to as USB ports 31, 32, 33 and 34.

Port numbers #1, #2, #3 and #4 are assigned to the USB ports 31, 32, 33 and 34. On the left side surface of the computer main body 11, numerals “1” and “2”, which are identification information indicative of the port numbers of the USB ports 31 and 32, are marked on peripheral areas of the USB ports 31 and 32. Similarly, on the rear side surface of the computer main body 11, numerals “3” and “4”, which are identification information indicative of the port numbers of the USB ports 33 and 34, are marked on peripheral areas of the USB ports 33 and 34. Viewing these numerals, the user can confirm which port numbers are assigned to which USB ports.

The external storage device 100 is composed of a storage device (USB storage device) with a USB-standard interface, such as a USB memory. The external storage device 100 incorporates a memory medium 101. The memory medium 101 is composed of a nonvolatile semiconductor memory such as a flash EEPROM.

The memory medium 101 is preformatted in a first format type corresponding to a hard disk (HD) image or in a second format type corresponding to a flexible disk (FD) image.

The first format type is a so-called “HD emulation format type” for handling the external storage device 100 as a virtual hard disk drive (HD-emulated drive). The second format type is a so-called “FD emulation format type” for handling the external storage device 100 as a virtual flexible disk drive (FD-emulated drive).

An external storage device 102, as shown in FIG. 3, can also be connected to the USB port and used. The external storage device 102 is a storage device having a USB-standard interface and accommodating a hard disk drive as a memory medium.

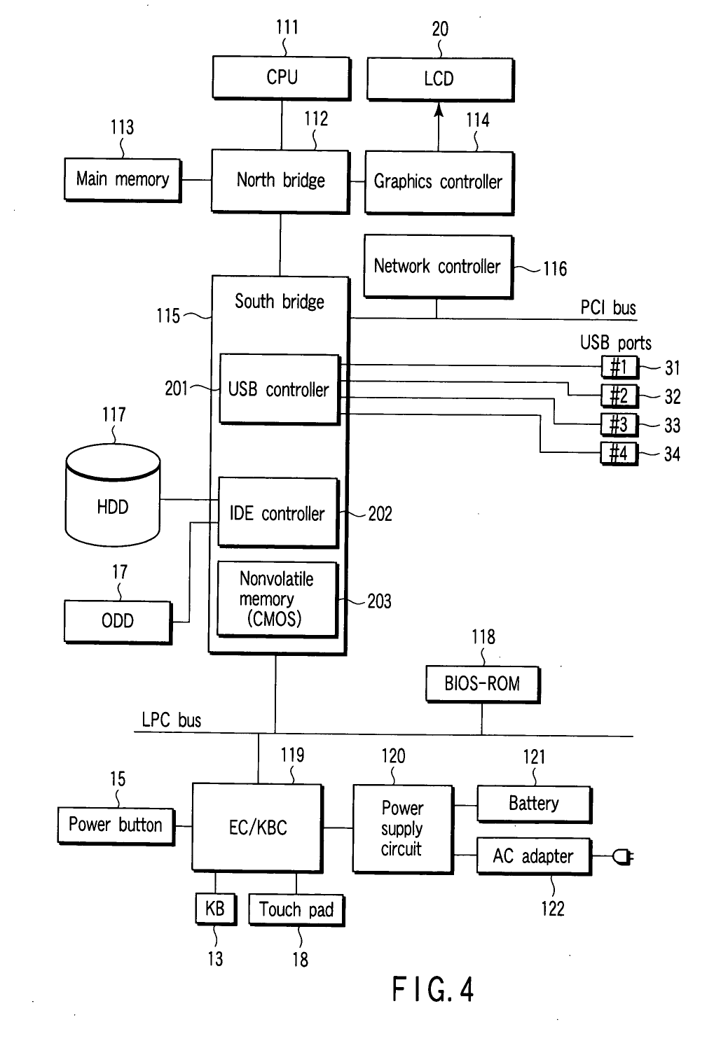

Next, referring to FIG. 4, an example of the system configuration of the computer 10 is described.

The computer 10 comprises a CPU 111, a north bridge 112, a main memory 113, a graphics controller 114, a south bridge 115, a network controller 116, a built-in hard disk drive (HDD) 117, a flash BIOS-ROM 118, an embedded controller/keyboard controller IC (EC/KBC) 119, and a power supply circuit 120.

The CPU 111 is a processor that controls the operation of the components of the computer 10. The CPU 111 executes an operating system and various application programs, which are loaded from the built-in HDD 117 or an external storage device into the main memory 113. The CPU 111 also executes a system BIOS (Basic Input/Output System) that is stored in the flash BIOS-ROM 118. The system BIOS is a program for hardware control. Responding to power-on of the computer 10, the system BIOS executes a POST (Power-On Self Test) process. In the POST process, the system BIOS executes operation tests and initializing processes for the respective components of the computer 10.

Further, in the POST process, the system BIOS determines whether an external storage device is connected to the USB port on a USB port by USB port basis. If an external storage device is connected to a certain USB port, the system BIOS assigns one of a first drive number (8xh) and a second drive number (0xh) to the external storage device. Which of the first drive number (8xh) and second drive number (0xh) is to be assigned is determined by mode designation information which is associated with each USB port, 31 to 34. The mode designation information is information that designates whether the external storage device, which is connected to the USB port corresponding to the mode designation information, is to be handled as a hard disk drive or a flexible disk drive. Specifically, the mode designation information designates one of a first mode (HD mode) and a second mode (FD mode). The first mode (HD mode) is a mode which designates handling of the external storage device as a hard disk drive. The second mode (FD mode) is a mode which designates handling of the external storage device as a flexible disk drive.

If the mode designation information corresponding to the USB port 31 indicates the first mode (HD mode), the system BIOS assigns a first drive number (8xh) to the external storage device in order to handle the external storage device, which is connected to the USB port 31, as a hard disk drive. The first drive number (8xh) is a drive number for designating the hard disk drive. In this manner, by assigning the first drive number (8xh), which is to be assigned to the hard disk drive, to the external storage device such as a USB memory, the external storage device can be handled as a virtual hard disk drive.

In order to normally handle the external storage device as a virtual hard disk drive, it is necessary that the memory medium of the external storage device be preformatted in the HD emulation format type. By connecting the external storage device, which is formatted in the HD emulation format type, to the USB port 31, the user can use the external storage device as the hard disk drive.

The value of the first drive number varies from hard disk drive to hard disk drive. If there are two hard disk drives, a drive number (80h) is assigned to the first hard disk drive and a drive number (81h) is assigned to the second hard disk drive.

If the mode designation information corresponding to the USB port 31 indicates the second mode (FD mode), the system BIOS assigns a second drive number (0xh) to the external storage device in order to handle the external storage device, which is connected to the USB port 31, as a flexible disk drive. The second drive number (0xh) is a drive number for designating the flexible disk drive. In this way, by assigning the second drive number (0xh), which is to be assigned to the flexible disk drive, to the external storage device such as a USB memory, the external storage device can be handled as a virtual flexible disk drive.

In order to normally handle the external storage device as a virtual flexible disk drive, it is necessary that the memory medium of the external storage device be preformatted in the FD emulation format type. By connecting the external storage device, which is formatted in the FD emulation format type, to the USB port 31, the user can use the external storage device as the flexible disk drive.

The value of the second drive number varies from flexible disk drive to flexible disk drive. If there are two flexible disk drives, a drive number (00h) is assigned to the first flexible disk drive and a drive number (01h) is assigned to the second flexible disk drive.

If the mode designation information corresponding to the USB port 31 indicates the first mode (HD mode) and the mode designation information corresponding to the USB port 32 indicates the second mode (FD mode), the system BIOS assigns the first drive number (8xh) to the external storage device which is connected to the USB port 31, and assigns the second drive number (0xh) to the external storage device which is connected to the USB port 32. Thus, if the user is to use the external storage device which is formatted in the HD emulation format type, he/she may connect it to the USB port 31. If the user is to use the external storage device which is formatted in the FD emulation format type, he/she may connect it to the USB port 32. Thereby, whether the external storage device is formatted in the HD emulation format type or the FD emulation format type, the user can use the external storage device. Furthermore, the use can use at the same time an external storage device which is formatted in the HD emulation format type and an external storage device which is formatted in the FD emulation format type.

The north bridge 112 is a bridge device that connects a local bus of the CPU 111 and the south bridge 115. The north bridge 112 has a function of executing communication with the graphics controller 114 via, e.g. an AGP (Accelerated Graphics Port) bus. The north bridge 112 includes a memory controller that controls the main memory 113.

The graphics controller 114 is a display controller for controlling the LCD 20 that is used as a display monitor of the computer 10. The south bridge 115 is connected to a PCI (Peripheral Component Interconnect) bus and an LPC (Low Pin Count) bus. In addition, the south bridge 115 includes a USB controller 201, an IDE (Integrated Drive Electronics) controller 202 and a nonvolatile memory 203. The USB controller 201 executes communication with external storage devices that are connected to the USB ports 31 to 34. The IDE controller 202 controls the built-in HDD 117 and the optical disc drive (ODD) 17.

The nonvolatile memory 203 is a memory which is called “CMOS memory”. The nonvolatile memory 203 is used for storing setup information that designates the operational environment of the computer 10. The setup information includes boot priority-order information, and the above-described mode designation information.

The embedded controller/keyboard controller IC (EC/KBC) 119 is a 1-chip microcomputer in which an embedded controller for power management and a keyboard controller for controlling the keyboard (KB) 13 and touch pad 18 are integrated. The embedded controller/keyboard controller IC 119 cooperates with the power supply circuit 120 to power on/off the computer 10 in response to the user's operation of the power button switch 15. The power supply circuit 120 generates system power, which is to be supplied to the components of the computer 10, using power from a battery 121 or external power supplied from an AC adapter 122.

Next, referring to FIG. 5, the functional configuration for controlling the external storage device is described.

The control of the external storage device is executed by a connection detection unit 302, a drive number assignment unit 303, a drive number table 304, an access process unit 305, a boot device determination unit 306 and a boot process unit 307. The connection detection unit 302, drive number assignment unit 303, access process unit 305, boot device determination unit 306 and boot process unit 307 are realized as function-executing modules (software modules) within the system BIOS.

The connection detection unit 302 executes, with respect to each of the USB ports 31 to 34, a connection detection process for determining whether an external storage device is connected to the USB port. If the external storage device is connected to any one of the USB ports, the drive number assignment unit 303 executes the process for assigning the drive number to the external storage device in accordance with the mode designation information corresponding to the USB port to which the external storage device is connected. The mode designation information corresponding to each of the USB ports 31 to 34 is stored in a mode information memory unit 301 within the nonvolatile memory 203. The mode designation information is information which designates the mode which is to be used in order to control the external storage device that is connected to the USB port corresponding to the mode designation information. The mode designation information designates one of the first mode (HD mode) and the second mode (FD mode).

The user is able to select one of the first mode (HD mode) and second mode (FD mode) on a USB port by USB port basis, using a BIOS setup function or a dedicated utility program. The BIOS setup function relating to the external storage device is executed by a setting screen display unit 401 and a mode designation information editing unit 402. The setting screen display unit 401 displays a setting screen for designating, on a USB port by USB port basis, whether the external storage device, which is connected to the USB port, is to be handled as a hard disk drive or a flexible disk drive. The mode designation information editing unit 402 executes an editing process for creating or altering a plurality of mode designation information items which are associated with the respective USB ports 31 to 34, in accordance with the user's operation which is executed on the setting screen. The user can select the first mode (HD mode) or second mode (FD mode) on the setting screen with respect to each of the USB ports on a USB port by USB port basis.

In the case where the mode designation information corresponding to the USB port, to which the external storage device is connected, indicates the first mode (HD mode), the drive number assignment unit 303 assigns the first drive number (8xh) to the external storage device. On the other hand, in the case where the mode designation information corresponding to the USB port, to which the external storage device is connected, indicates the second mode (FD mode), the drive number assignment unit 303 assigns the second drive number (0xh) to the external storage device.

The drive number assignment unit 303 stores, in the drive number table 304, information which indicates the relationship between the USB ports and the drive numbers assigned to the external storage devices connected to the USB ports.

Referring to the drive number table 304, the access process unit 305 recognizes which drive number is assigned to the external storage device on a USB port by USB port basis. In the case where the first drive number (8xh) is assigned to the external storage device which is connected to a given USB port, the access process unit 305 accesses the external storage device, which is connected to this USB port, in response to a disk access request designating the first drive number (8xh), which is sent from software (e.g. installer, operating system, other routines in the system BIOS, etc.). On the other hand, in the case where the second drive number (0xh) is assigned to the external storage device which is connected to a given USB port, the access process unit 305 accesses the external storage device, which is connected to this USB port, in response to a disk access request designating the second drive number (0xh), which is sent from the software.

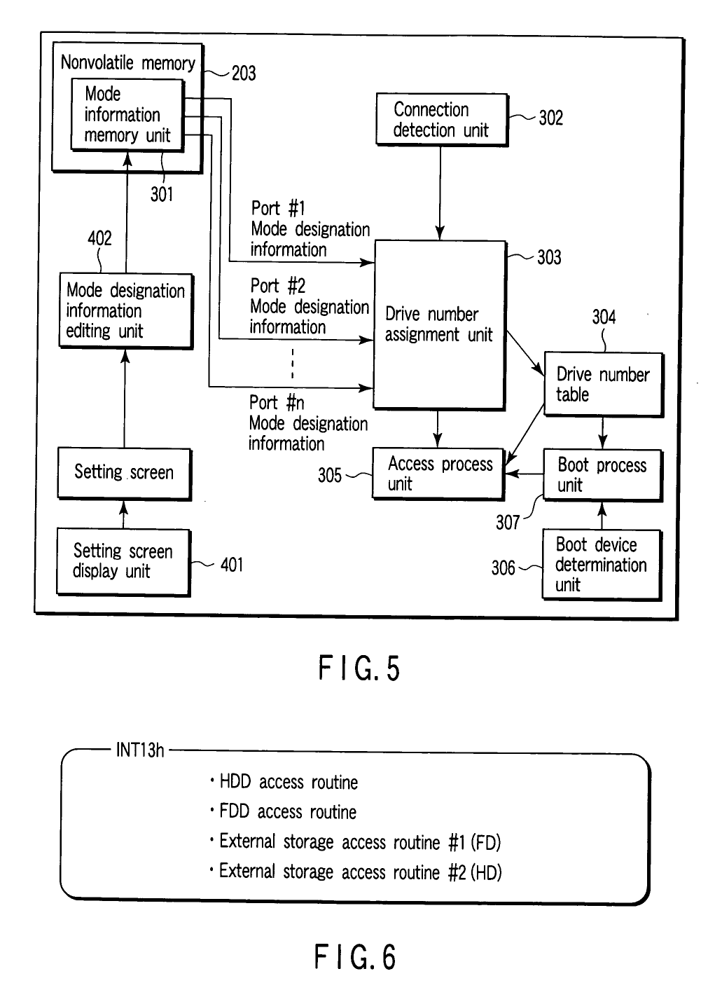

The access process unit 305 is realized by a disk driver routine in the system BIOS. The disk driver routine is a program that is executed by a software interrupt (INT13h). The disk driver routine, as shown in FIG. 6, includes an HDD access routine for accessing a hard disk drive (HDD), an FDD routine for accessing a flexible disk drive (FDD), and two external storage access routines. One of the external storage access routines, #1, is a routine for accessing the external storage device of the second format type (FD emulation format type) via the USB controller 201 in response to a disk access request for the flexible disk drive. The other external storage access routine #2 is a routine for accessing the external storage device of the first format type (HD emulation format type) via the USB controller 201 in response to a disk access request for the hard disk drive.

In the case where the second drive number (0xh) is assigned to the external storage device which is connected to a given USB port, the access process unit 305 executes the external storage access routine #1 when the access process unit 305 receives from the software a disk access request including the second drive number (0xh) as an argument, and accesses the external storage device which is connected to this USB port. The external storage access routine #1 executes emulation from the procedure for accessing the flexible disk drive, which is executed by the software, to the procedure for accessing the external storage device. Hence, the software can handle the external storage device like the flexible disk drive simply by executing the ordinary process for accessing the flexible disk drive.

On the other hand, in the case where the first drive number (8xh) is assigned to the external storage device which is connected to a given USB port, the access process unit 305 executes the external storage access routine #2 when the access process unit 305 receives from the software a disk access request including the first drive number (8xh) as an argument, and accesses the external storage device which is connected to this USB port. The external storage access routine #2 executes emulation from the procedure for accessing the hard disk drive, which is executed by the software, to the procedure for accessing the external storage device. Hence, the software can handle the external storage device like the hard disk drive simply by executing the ordinary process for accessing the hard disk drive.

The boot device determination unit 306 determines, with respect to each external storage device, whether the external storage device is a boot device or not, on the basis of the drive numbers, which are assigned to the respective external storage devices connected to the USB ports 31 to 34, and the above-described boot priority-order information. In the case where the external storage device is determined as the boot device, the boot process unit 307 executes a process for booting up the computer 10 from the external storage device. In the boot-up process, the boot process unit 307 issues a disk access request to the access process unit 305. This disk access request includes as an argument the drive number assigned to the external storage device which is determined as the boot device. Thereby, the system program, such as the operating system, which is stored in the external storage device, is loaded in the main memory 113 and is executed.

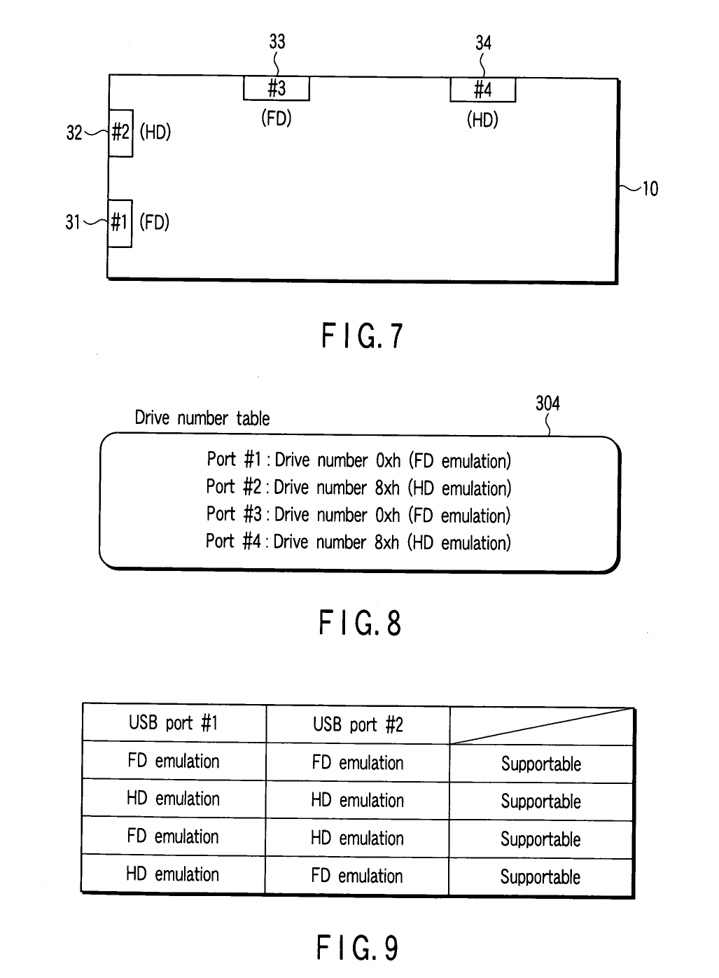

FIG. 7 shows an example of mode assignment to the USB ports 31 to 34 provided on the computer 10. In FIG. 7, the second mode (FD mode) is assigned to the USB port 31 with the port number #1. The first mode (HD mode) is assigned to the USB port 32 with the port number #2. The second mode (FD mode) is assigned to the USB port 33 with the port number #3. The first mode (HD mode) is assigned to the USB port 34 with the port number #4.

In the case where external storage devices are connected to the respective USB ports 31 to 34, the drive numbers are assigned to the four external storage devices, as shown in FIG. 8.

In the present embodiment, whether the external storage device is to be handled as a hard disk drive or a flexible disk drive can be designated, on a USB port by USB port basis, by a plurality of mode designation information items corresponding to the plural USB ports.

If single common mode designation information is used for all the USB ports, the first drive number corresponding to the hard disk drive is assigned to all the external storage devices, or the second drive number corresponding to the flexible disk drive is assigned to all the external storage devices,

If the single mode designation information indicates the HD mode, only the external storage device of the first format type (HD emulation format type) is usable. In order to use the external storage device of the second format type (FD emulation format type), it is necessary to alter the value of the mode designation information to the FD mode and then to restart the computer.

If the single mode designation information indicates the FD mode, only the external storage device of the second format type (FD emulation format type) is usable. In order to use the external storage device of the first format type (HD emulation format type), it is necessary to alter the value of the mode designation information to the HD mode and then to restart the computer.

In the present embodiment, it is predetermined whether the external storage device is to be used as a flexible disk drive or a hard disk drive on a USB port by USB port basis. Thereby, without restarting the computer 10, either of the external storage device of the first format type (HD emulation format type) and the external storage device of the second format type (FD emulation format type) can be used.

For example, in the case where the number of USB ports provided on the computer 10 is two, the following four modes of use can be supported as shown in FIG. 9:

(1) USB port #1=FD emulation, USB port #2=FD emulation

(2) USB port #1=HD emulation, USB port #2=HD emulation

(3) USB port #1=FD emulation, USB port #2=HD emulation

(4) USB port #1=HD emulation, USB port #2=FD emulation.

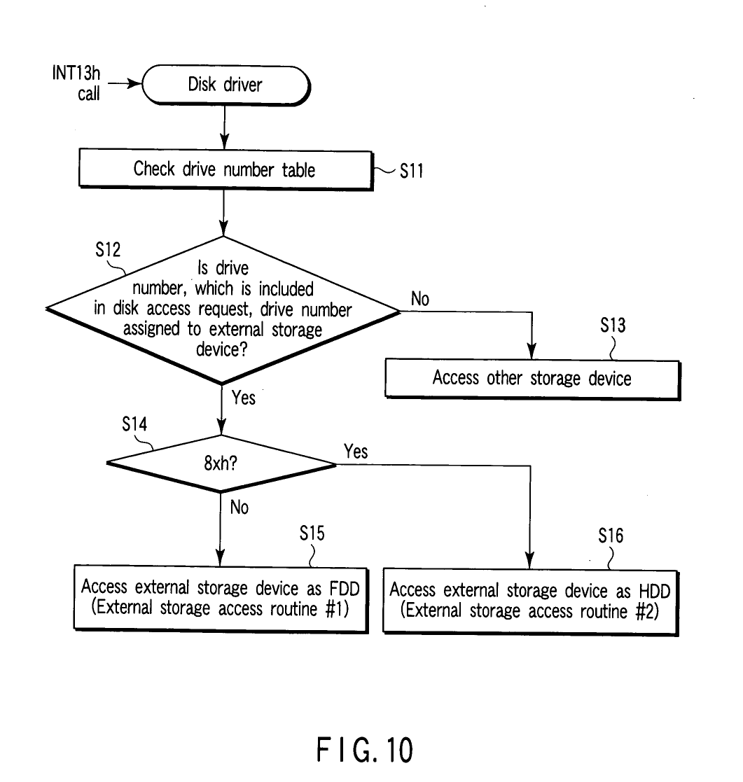

Next, referring to a flow chart of FIG. 10, the operation of the access process unit (disk driver) 305 is described.

When the disk driver is called by software, the access process unit 305 checks the drive number table 304 (block S11) and determines whether the drive number, which is included in the disk access request from the software, is a drive number which is assigned to any one of the external storage devices (block S12).

If the drive number, which is included in the disk access request from the software, is not assigned to any one of the external storage devices (NO in block S12), the access process unit 305 accesses a device (e.g. the built-in HDD, FDD), other than the external storage device, by the HDD access routine or FDD access routine (block S13).

If the drive number, which is included in the disk access request from the software, is the drive number that is assigned to any one of the external storage devices (YES in block S12), the access process unit 305 determines whether the drive number included in the disk access request is the first drive number (8xh) or not (block S14).

If the drive number included in the disk access request is not the first drive number (8xh), that is, if the drive number included in the disk access request is the second drive number (0xh) (NO in block S14), the access process unit 305 executes the external storage access routine #1 and accesses the external storage device to which the second drive number (0xh) is assigned (block S15).

If the drive number included in the disk access request is the first drive number (8xh) (YES in block S14), the access process unit 305 executes the external storage access routine #2 and accesses the external storage device to which the first drive number (8xh) is assigned (block S16).

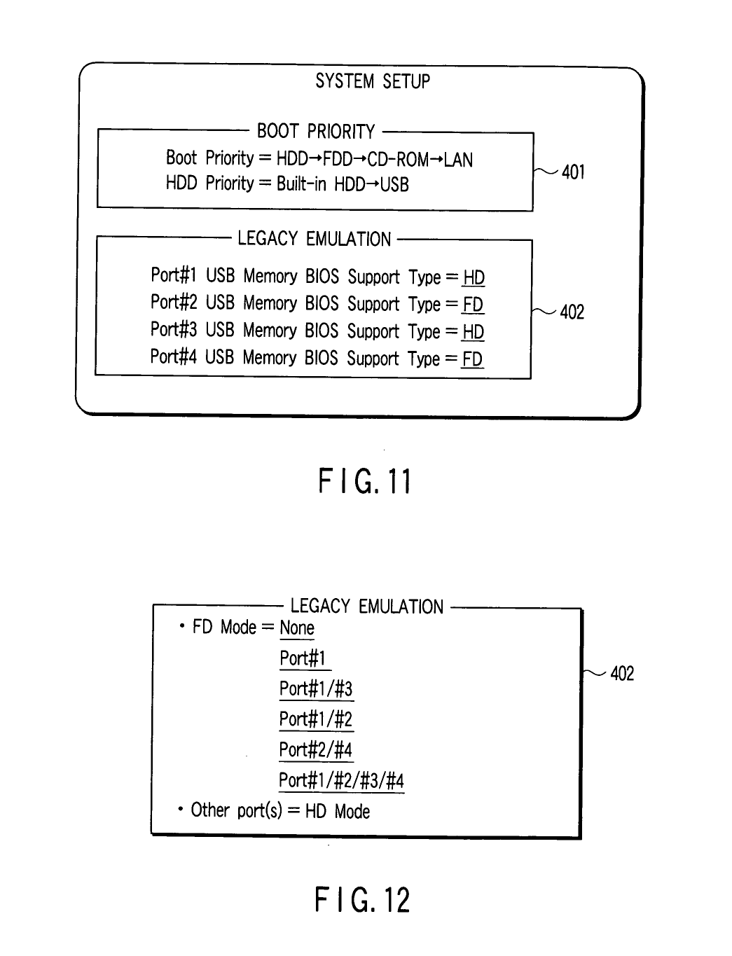

FIG. 11 shows an example of a system setup screen which is displayed on the LCD 20 by the system BIOS.

The system setup screen is a setting screen for setting the operational environment of the computer 10. The system setup screen includes, as a setup menu, a “BOOT PRIORITY” field 401 and a “LEGACY EMULATION” field 402. The “BOOT PRIORITY” field 401 includes a “Boot Priority” item for setting boot priority-order information, and an “HDD Priority” item for setting HDD priority-order information.

The boot priority-order information is information which designates the order of use of disk drives for system boot-up. A standard value of the boot priority-order information is, for example,

HDD→FDD→CD-ROM→LAN.

The user may move the cursor to the “Boot Priority” item and press the space key, thus being able to alter the boot priority-order information. In the boot priority-order information, “HDD” represents a built-in HDD or an external storage device (e.g. USB memory) to which the first drive number (8xh) is assigned, and “FDD” represents an FDD or an external storage device (e.g. USB memory) to which the second drive number (0xh) is assigned.

The HDD priority-order information is information which designates a priority order between the built-in HDD and the external storage device (e.g. USB memory). A standard value of the HDD priority-order information is, for example,

Built-in HDD→External storage device (USB memory).

The user may move the cursor to the “HDD Priority” item and press the space key, thus being able to alter the HDD priority-order information to

External storage device (USB memory) Built-in HDD.

The “LEGACY EMULATION” field 402 includes four items “Port #1 USB Memory BIOS Support Type”, “Port #2 USB Memory BIOS Support Type”, “Port #3 USB Memory BIOS Support Type” and “Port #4 USB Memory BIOS Support Type” for setting the mode designation information items corresponding to the USB ports #1 to #4. The user may move the cursor to the item corresponding to the USB port for the object of setting, and press the space key, thus being able to select “HD mode” or “FD mode” on a USB port by USB port basis.

As is shown in FIG. 12, a plurality of candidates, which indicate combinations of USB ports to be used for the “FD” mode, may be predetermined. The user can select a candidate to be used, by pressing the space key.

For example, if “FD mode=None” is selected, the HD mode is assigned to all USB ports. If “FD mode=Port #1” is selected, the FD mode is assigned to the USB port #1, and the HD mode is assigned to the other USB ports #2 to #4. If “FD mode=Port #1/#3” is selected, the FD mode is assigned to the USB ports #1 and #3, and the HD mode is assigned to the other USB ports #2 and #4. If “FD mode=Port #1/#2” is selected, the FD mode is assigned to the USB ports #1 and #2, and the HD mode is assigned to the other USB ports #3 and #4. If “FD mode=Port #2/#4” is selected, the FD mode is assigned to the USB ports #2 and #4, and the HD mode is assigned to the other USB ports #1 and #3. If “FD mode=Port #1/#2/#3/#4” is selected, the FD mode is assigned to all the USB ports.

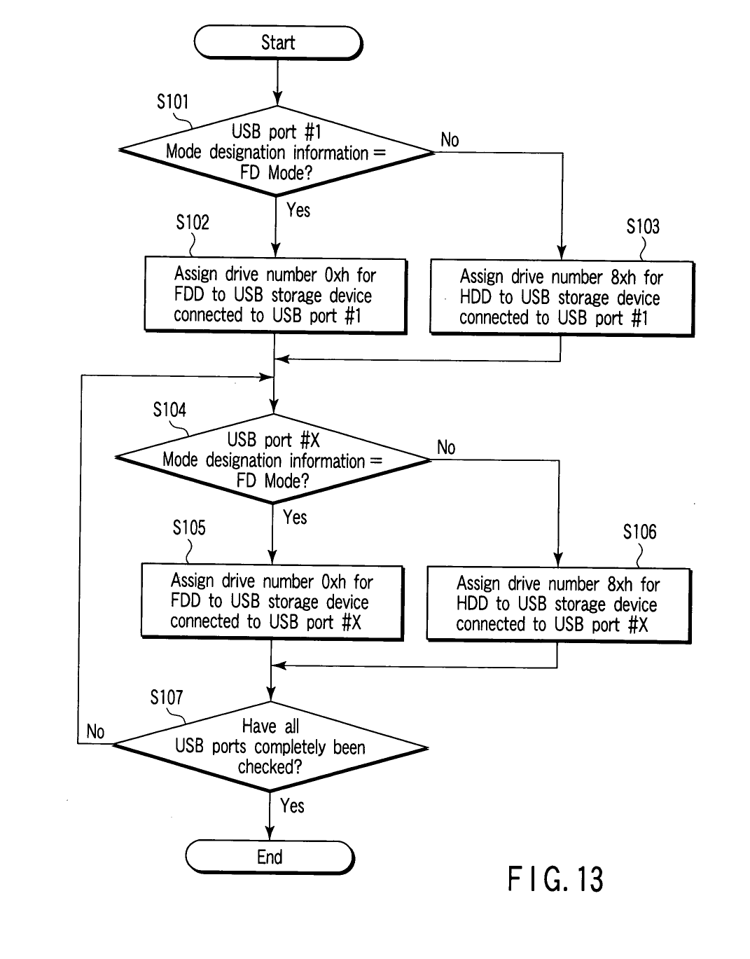

Next, referring to a flow chart of FIG. 13, the operation of the drive number assignment unit 303 is described.

It is assumed that external storage devices are connected to all the USB ports.

To start with, the drive number assignment unit 303 determines whether the mode designation information corresponding to the port number #1 indicates the FD mode (block S101). If the mode designation information corresponding to the port number #1 is the FD mode (YES in block S101), the drive number assignment unit 303 assigns the second drive number (0xh) to the external storage device (e.g. a USB storage device such as a USB memory) which is connected to the port number #1 (block S102). On the other hand, if the mode designation information corresponding to the port number #1 indicates the HD mode (NO in block S101), the drive number assignment unit 303 assigns the first drive number (8xh) to the external storage device which is connected to the port number #1 (block S103).

Subsequently, while updating the port number, the drive number assignment unit 303 executes a process of assigning the first drive number (8xh) or second drive number (0xh) to each of the other USB ports (blocks S104 to 107).

Thus, the drive numbers are assigned to the external storage devices corresponding to all the USB ports.

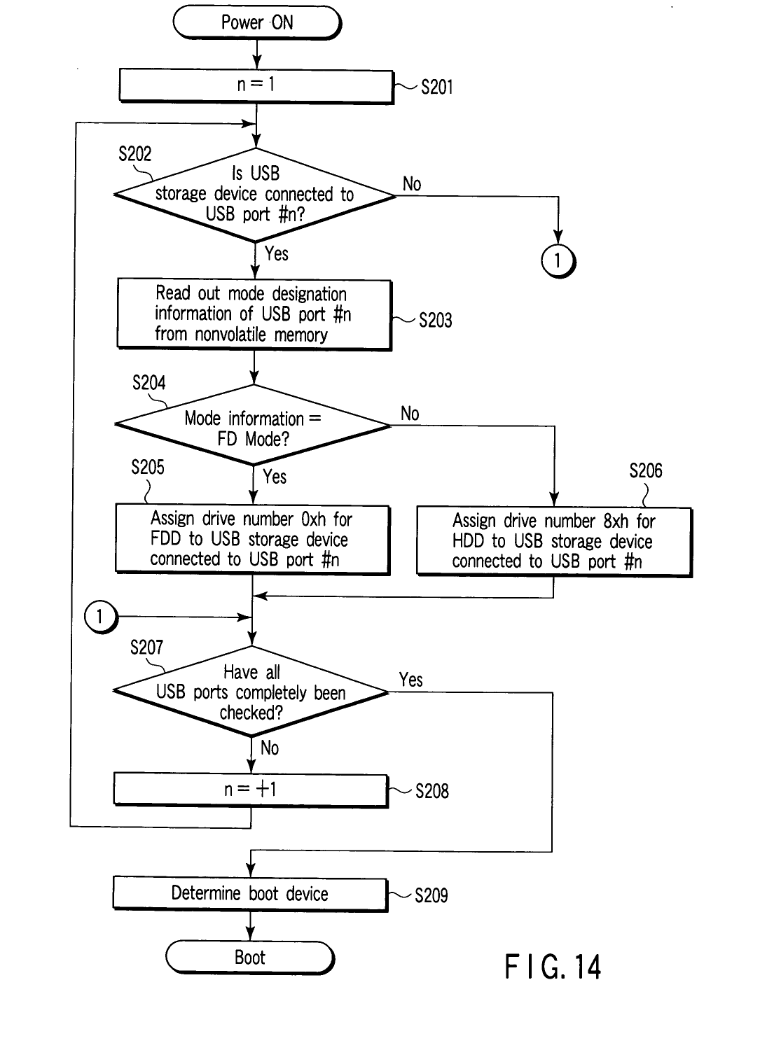

Next, referring to a flow chart of FIG. 14, a description is given of the procedure of a process which is executed by the system BIOS when the computer 10 is powered on.

When the computer main body 11 is powered on, the CPU 111 executes the system BIOS, thereby performing the following process.

To start with, the CPU 111 sets a variable n at 1 (block S201). Then, the CPU 111 determines whether an external storage device (e.g. a USB storage device such as a USB memory) is connected to the USB port #n (block S202).

If the external storage device is not connected to the USB port #n (NO in block S202), the CPU 111 determines whether all USB ports have completely been checked (block S207). If all USB ports have not completely been checked (NO in block S207), the CPU 111 increments the value of variable n by +1 (block S208) and executes the process of block S202 once again.

If the external storage device is connected to the USB port #n (YES in block S202), the CPU 111 reads from the nonvolatile memory 203 the mode designation information corresponding to the port number #n (block S203). The CPU 111 determines whether the mode designation information corresponding to the port number #n indicates the FD mode or the HD mode (block S204).

If the mode designation information corresponding to the port number #n indicates the FD mode (YES in block S204), the CPU 111 assigns the second drive number (0xh) for the FDD to the external storage device that is connected to the USB port #n, thereby to handle the external storage device, which is connected to the USB port #n, as the FDD (block S205). Thus, the external storage device is accessed as the FDD from the software.

On the other hand, if the mode designation information corresponding to the port number #n indicates the HD mode (NO in block S204), the CPU 111 assigns the first drive number (8xh) for the HDD to the external storage device that is connected to the USB port #n, thereby to handle the external storage device, which is connected to the USB port #n, as the HDD (block S206). Thus, the external storage device is accessed as the HDD from the software.

Subsequently, the CPU 111 determines whether all USB ports have completely been checked (block S207). If all USB ports have not completely been checked (NO in block S207), the CPU 111 increments the value of variable n by +1 (block S208) and executes the process of block S202 once again.

If all USB ports have completely been checked (YES in block S207), the CPU 111 executes the process for determining the boot device (block S209). In block S209, the CPU 111 determines whether the external storage device is the boot device or not, on the basis of the boot priority-order information and the drive number (8xh or 0xh) that is assigned to the external storage device. For example, if the external storage device with the drive number 00h is present and the FDD is designated as a device with the highest priority by the boot priority-order information, the external storage device with the drive number 00h is determined as the boot device and the process for booting up the computer 10 from the external storage device is executed. If the external storage device with the drive number 80h is present and the HDD is designated as a device with the highest priority by the boot priority-order information, the external storage device with the drive number 80h is determined as the boot device and the process for booting up the computer 10 from the external storage device is executed.

As has been described above, in the present embodiment, one of the FD mode and HD mode is assigned to each of the connection ports on the basis of the mode designation information which is prepared for the connection ports on a connection port by connection port basis. The second drive number for designating the flexible disk drive is assigned to the external storage device that is connected to the connection port to which the FD mode is designated. The first drive number for designating the hard disk drive is assigned to the external storage device that is connected to the connection port to which the HD mode is designated. Thus, the user is able to handle the external storage device as the user's intended disk drive (flexible disk drive or hard disk drive), without equipping the external storage device with a special function. Therefore, the user can easily boot up the operating system from the external storage device such as the USB memory, or install the operating system into the USB memory.

Furthermore, by designating the HD mode to a certain connection port and the FD mode to another connection port, it becomes possible to use at the same time the external storage device which is formatted in the HD emulation format type and the external storage device which is formatted in the FD emulation format type.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a plurality of connection ports which are provided in the main body and to which external storage devices are detachably connectable;
a nonvolatile memory which stores a plurality of mode designation information items which correspond to the plurality of connection ports and designate whether each of the external storage devices connected to the associated connection ports is to be handled as a hard disk drive or a flexible disk drive;
a connection detection unit which executes a connection detection process for determining whether the external storage devices are connected to the connection ports on a connection port by connection port basis; and
a drive number assignment unit which assigns, in a case where the external storage device is connected to at least one of the plurality of connection ports, one of a first drive number which designates the hard disk drive and a second drive number which designates the flexible disk drive to the external storage device connected to said at least one of the connection ports, based on the mode designation information corresponding to said at least one of the connection ports.

2. The information processing apparatus according to claim 1, further comprising:
a setting screen display unit which displays a setting screen for designating, with respect to each of the connection ports, whether the external storage device connected to the connection port is to be handled as the hard disk drive or the flexible disk drive; and
a mode designation information editing unit which executes an editing process for creating or altering the plurality of mode designation information items in accordance with a user's operation which is executed on the setting screen.

3. The information processing apparatus according to claim 1, further comprising:
an access process unit which accesses, in a case where the first drive number is assigned to the external storage device connected to said at least one of the connection ports, the external storage device connected to said at least one of the connection ports in response to a disk access request designating the first drive number, and accesses, in a case where the second drive number is assigned to the external storage device connected to said at least one of the connection ports, the external storage device connected to said at least one of the connection ports in response to a disk access request designating the second drive number.

4. The information processing apparatus according to claim 1, further comprising:
a boot device determination unit which determines whether the external storage device connected to said at least one of the connection ports is a boot device based on boot priority-order information and the drive number which is assigned to the external storage device connected to said at least one of the connection ports; and
a boot process unit which executes a process of booting up the information processing apparatus from the external device connected to said at least one of the connection ports in a case where the external storage device connected to said at least one of the connection ports is determined as the boot device.

5. The information processing apparatus according to claim 1, wherein each of the connection ports is a connector which supports a Universal Serial Bus standard, and each of the external storage devices is a device which has an interface supporting the Universal Serial Bus standard and incorporates a nonvolatile semiconductor memory as a memory medium.

6. The information processing apparatus according to claim 1, wherein each of the connection ports is a connector which supports a Universal Serial Bus standard, and each of the external storage devices is a device which has an interface supporting the Universal Serial Bus standard and incorporates a hard disk drive as a memory medium.

7. An access method for accessing external storage devices which are detachably connected to a plurality of connection ports which are provided in an information processing apparatus, the information processing apparatus being provided with a nonvolatile memory which stores a plurality of mode designation information items which correspond to the plurality of connection ports and designate whether each of the external storage devices connected to the associated connection ports is to be handled as a hard disk drive or a flexible disk drive, the access method comprising:
determining whether the external storage devices are connected to the connection ports on a connection port by connection port basis; and
assigning, in a case where the external storage device is connected to at least one of the plurality of connection ports, one of a first drive number which designates the hard disk drive and a second drive number which designates the flexible disk drive to the external storage device connected to said at least one of the connection ports, based on the mode designation information corresponding to said at least one of the connection ports.

8. The access method according to claim 7, further comprising:
displaying a setting screen for designating, with respect to each of the connection ports, whether the external storage device connected to the connection port is to be handled as the hard disk drive or the flexible disk drive; and
executing an editing process for creating or altering the plurality of mode designation information items in accordance with a user's operation which is executed on the setting screen.

9. The access method according to claim 7, further comprising:
accessing, in a case where the first drive number is assigned to the external storage device connected to said at least one of the connection ports, the external storage device connected to said at least one of the connection ports in response to a disk access request designating the first drive number; and
accessing, in a case where the second drive number is assigned to the external storage device connected to said at least one of the connection ports, the external storage device connected to said at least one of the connection ports in response to a disk access request designating the second drive number.

10. The access method according to claim 7, further comprising:
determining whether the external storage device connected to said at least one of the connection ports is a boot device based on boot priority-order information and the drive number which is assigned to the external storage device connected to said at least one of the connection ports; and
executing a process of booting up the information processing apparatus from the external device connected to said at least one of the connection ports in a case where the external storage device connected to said at least one of the connection ports is determined as the boot device.
